(19) United States
(12) Patent Application Publication
(10) Pub. No.: US 2008/0302395 A1
(43) Pub. Date: Dec. 11, 2008

(54) WET PROCESSING APPARATUS AND METHOD FOR DISCHARGING PARTICLES ALONG HORIZONTAL LIQUID FLOW

(75) Inventor: Kenji TANAKA, Tokyo (JP)

Correspondence Address: YOUNG & THOMPSON, 209 Madison Street, Suite 500, ALEXANDRIA, VA, 22314, US

(73) Assignee: ELPIDA MEMORY, INC., TOKYO (JP)

(21) Appl. No.: 12/135,509

(22) Filed: Jun. 9, 2008

(30) Foreign Application Priority Data
Jun. 11, 2007 (JP) 2007-153915

(51) Int. Cl. B08B 3/04

(52) U.S. Cl. 134/34; 134/133; 134/111

(57) ABSTRACT

A wet processing apparatus includes a processing vessel for containing a processing liquid and holding at least one wafer which is immersed in the processing liquid, wherein the processing vessel has an opening, provided on an upper side thereof, for loading and removing each wafer; and a processing-liquid supply mechanism which has outlets at a first side wall of the processing vessel. A discharge hole for discharging the processing liquid jetted from the outlets is provided at a second side wall of the processing vessel, where the second side wall faces the first side wall, and the outlets face the discharge hole. An outside vessel for containing the processing liquid, which overflows from the opening of the processing vessel, may be provided so as to surround the peripheral edge of the opening. A pump for circulating the processing liquid and a filter for filtering the processing liquid may be provided.

### BACKGROUND OF THE INVENTION

1. Field of the Invention

The present invention relates to a wet processing apparatus, more specifically, those apparatuses for performing cleaning or etching of a semiconductor device while preventing re-adhesion of particles to the device, and also relates to a relevant wet processing method.

Priority is claimed on Japanese Patent Application No. 2007-153915, filed Jun. 11, 2007, the contents of which are incorporated herein by reference.

2. Description of the Related Art

Generally, in a process of cleaning a semiconductor wafer, a batch processing using a vessel having a large capacity is performed.

FIG. 6A shows an example of a batch-type cleaning vessel. That is, a pipe system 12 for drawing a chemical liquid or pure water is connected to a processing vessel 2c for cleaning and rinsing wafers. In addition, processing-liquid supply mechanisms 14 are provided at the bottom or a side face of the processing vessel 2c, and are coupled to the pipe system 12. A processing liquid is jetted at a specific flow rate and speed, from the bottom or a side of the processing vessel 2c via outlets 14a of the processing-liquid supply mechanisms 14. The liquid is made to overflow from an opening 8 on the upper side of the vessel 2c. The overflowing liquid is disposed of, or the pipe system 12 may be coupled with the bottom part of an outside vessel 9 so as to circulate the overflowing liquid via a circulation pump 10 and a filter 11.

When cleaning each wafer W, the chemical liquid or water used for the cleaning flows from the bottom or a side of the processing vessel 2c toward the upper side thereof, and as shown in FIG. 6B, the liquid which reaches the air-liquid boundary (between the liquid and air) is discharged to the outside of the vessel 2c when the liquids overflows (see FIG. 6B). In this process, even though particles D generated from the wafers W are forwarded along the relevant liquid flow (in the vessel) to the air-liquid boundary on the upper side of the vessel, they tend to stay at the air-liquid boundary, and thus are not easily discharged to the outside of the vessel 2c (see FIG. 6C).

As shown in FIG. 6D, when the wafers W are pulled out after the cleaning, and the next wafers W are loaded, each wafer passes through the air-liquid boundary. Therefore the particles D which stay at the air-liquid boundary are again adhered to the cleaned wafers W when they pass through the air-liquid boundary. If such wafers having adhered particles are supplied to a semiconductor manufacturing process, defects tend to occur.

In known methods for discharging and removing the particles D at the air-liquid boundary, (i) the amount of overflow of the chemical liquid or water is increased, (ii) in a wet processing apparatus 1D (see FIGS. 7A), notches 8a are provided at an opening 8A of a processing vessel 2D so as to efficiently discharge the overflowing chemical liquid, or (iii) in a wet processing apparatus 1E (see FIG. 7B), the wafers W are swayed in a processing vessel 2E so as to improve the discharge performance. However, no considerable effect can be obtained by the above methods.

As a method for controlling the liquid flow in the batch-type processing vessel, Patent Document 1 discloses a cleaning apparatus in which a carrier for containing wafers is provided in a cleaning vessel, and a cleaning liquid is supplied through the holes of a drain board, which is provided at the bottom of the carrier. The cleaning liquid is then discharged from the upper side of the carrier, or through the holes provided at side walls of the cleaning vessel.

In addition, Patent Document 2 discloses a wet processing apparatus 1F (see FIGS. 7C) in which processing-liquid supply mechanisms 15, each having outlets 15a, are provided at the side and bottom faces of a processing vessel 2F. A processing liquid is supplied from a bottom part 16 of the vessel 2F while a processing liquid is also supplied through the outlets 15a so as to generate a turbulent flow inside the vessel, which helps the overflow of the processing liquid.

Additionally, Patent Document 3 discloses a cleaning apparatus in which shower nozzles are provided on the upper and lower sides of the liquid surface of a contained cleaning liquid, so as to control the flow of the cleaning liquid in a manner such that it is supplied from the upper side of a wafer, and discharged through a suction hole provided at the bottom of a cleaning vessel.
Patent Document 1: Japanese Unexamined Patent Application, First Publication No. H2-44727.
Patent Document 2: Japanese Unexamined Patent Application, First Publication No. H6-53205.
Patent Document 3: Japanese Unexamined Patent Application, First Publication No. 2000-173962.

However, in conventional apparatuses in accordance with the above-described methods, the relevant particles are still not efficiently discharged, so that they are adhered again to the wafers before they are pulled out from the vessel. Therefore, substandard products (wafers) are produced, and a decrease in the relevant yield occurs due to such re-adhesion of the particles.

In the cleaning apparatus of Patent Document 1, as the cleaning liquid flows from the lower side to the upper side, the particles stay at the air-liquid boundary, similar to the above-described conventional structure.

In the wet processing apparatus of Patent Document 2, even though the processing liquid is jetted along various directions, the liquid is finally discharged by means of overflow due to the effects of gravity. Therefore, no sufficient effect can be obtained by this structure. In addition, as the liquid is discharged toward the air-liquid boundary, a large number of particles stay at the air-liquid boundary.

In the cleaning apparatus of Patent Document 3, even though the cleaning liquid flows from the upper to lower side, it is difficult for light particles to sink toward the lower side of the cleaning vessel.

### SUMMARY OF THE INVENTION

In light of the above circumstances, an object of the present invention is to provide a wet processing apparatus and a relevant method, so as to perform cleaning, etching, or the like of a semiconductor wafer in a clean state, without making particles stay at the air-liquid boundary of the processing vessel.

Therefore, the present invention provides a wet processing apparatus comprising:

a processing vessel for containing a processing liquid and holding at least one wafer which is immersed in the processing liquid, wherein the processing vessel has an opening, provided on an upper side of the processing vessel, for loading and removing each wafer; and

a processing-liquid supply mechanism which has outlets at a first side wall of the processing vessel wherein:

a discharge hole for discharging the processing liquid jetted from the outlets is provided at a second side wall of the processing vessel, where the second side wall faces the first side wall, and the outlets face the discharge hole.

Therefore, a substantially horizontal flow of the processing liquid can be obtained, and it is possible to prevent the particles, whose specific gravity is smaller than that of the processing liquid, from moving toward the air-liquid boundary due to the buoyancy of the particles, by means of the hydraulic pressure of the liquid flow,

In a preferable example:

an outside vessel for containing the processing liquid, which overflows from the opening of the processing vessel, is provided so as to surround the peripheral edge of the opening; and

a pump for circulating the contained processing liquid and a filter for filtering the processing liquid are provided at piping which is coupled to the bottom of the outside vessel and the processing-liquid supply mechanism.

In this case, the processing liquid, which has been used for the wet processing, can be reused by circulating it using the pump while removing the particles by means of the filter. Therefore, the processing can be efficiently performed.

In another preferable example, a discharge pump for forcibly discharging the processing liquid is coupled to the discharge hole. Accordingly, the liquid flow can be forcibly controlled, and it is possible to reduce a turbulent flow while further preventing the upward movement of the particles, thereby improving uniformity along the faces of wafers with respect to the effects of wet etching or rinsing.

In another preferable example, the first and second side walls have assistant outlets which are provided above the outlets of the processing-liquid supply mechanism and have substantially the same height; and

the processing liquid is jetted from the assistant outlets toward the boundary between the processing liquid and air at the opening of the processing vessel.

Accordingly, immediately before removing each wafer from the processing vessel, the processing liquid jetted from the assistant outlets can forcibly make a small number of particles, which stay at the air-liquid boundary, overflow, thereby effectively preventing re-adhesion of the particles.

In another preferable example, the opening is provided so as to load and remove each wafer in a direction substantially perpendicular to a substantially horizontal flow of the processing liquid. That is, as the loading and removing direction is perpendicular to the direction in which the particles (removed by the processing liquid) flow, they do not tend to adhere to the wafer again when the wafer is pulled out.

Typically, the hydraulic pressure of a substantially horizontal flow from the outlets to the discharge hole is higher than the buoyancy of particles generated from each wafer. Accordingly, the particles do not move upward in the processing liquid, and they do not stay at the air-liquid boundary. Also when pulling out each wafer, the wafer can be removed from the liquid without bringing the particles.

The present invention also provides a wet processing method comprising the steps of:

storing a processing liquid in a processing vessel;

loading at least one wafer from an opening, provided on an upper side of the processing vessel, and holding each wafer, which is immersed in the processing liquid, in the processing vessel;

jetting the processing liquid from outlets of a processing-liquid supply mechanism provided at a first side wall of the processing vessel;

discharging the processing liquid from a discharge hole provided at a second side wall of the processing vessel, where the second side wall faces the first side wall, so as to produce a substantially horizontal flow of the processing liquid; and

removing particles, which are generated from each wafer, along the horizontal flow of the processing liquid, so as to perform a wet processing without making the particles stay at the boundary between the processing liquid and air at the opening of the processing vessel.

Accordingly, as the particles do not stay at the air-liquid boundary through which the wafer is pulled out, the wafer can be removed from the liquid without bringing the particles.

In a preferable example:

the processing liquid, which overflows from the opening of the processing vessel, is contained in an outside vessel provided so as to surround the peripheral edge of the opening, and then circulated through piping at which a filter and a pump are provided, so that the processing liquid is jetted from the outlets, which are coupled with the bottom of the outside vessel, after removing the particles, which are included in the processing liquid, through the filter.

Accordingly, the processing liquid, which has been used for the wet processing, can be reused by circulating it while removing the particles. Therefore, the processing can be efficiently performed.

In another preferable example, the wet processing is performed while forcibly discharging the processing liquid by using a discharge pump coupled to the discharge hole. Accordingly, the wet processing can be performed while the liquid flow can be forcibly controlled. Therefore, it is possible to reduce a turbulent flow, thereby improving uniformity along the faces of wafers with respect to the effects of wet etching or rinsing.

In another preferable example, immediately before removing each wafer from the processing vessel when the wet processing is completed, the processing liquid is jetted toward the boundary between the processing liquid and air, from assistant outlets which are provided at the first and second side walls and above the outlets of the processing-liquid supply mechanism, and have substantially the sane height.

Accordingly, the processing liquid jetted from the assistant outlets can forcibly make a small number of particles, which stay at the air-liquid boundary, overflow, thereby effectively preventing re-adhesion of the particles.

The present invention also provides a processing apparatus comprising:

a processing vessel for containing a processing liquid and holding at least one object which is immersed in the processing liquid, wherein:

an outlet which supplies the processing vessel with the processing liquid is provided; and

a discharge hole is provided at an inner side wall of the processing vessel, so as to discharge the processing liquid.

The processing vessel may have another discharge hole so as to discharge the processing liquid which overflows.

### BRIEF DESCRIPTION OF THE DRAWINGS

FIG. 1 is a perspective view showing a wet processing apparatus as a first embodiment of the present invention.

FIG. 2 is a sectional view showing the wet processing apparatus of the first embodiment.

FIG. 3 is a sectional view showing a wet processing apparatus as a second embodiment of the present invention.

FIG. 4 is a sectional view showing a wet processing apparatus as a third embodiment of the present invention.

FIGS. 5A to 5D are diagrams for explaining a wet processing method using the wet processing apparatus of the first embodiment, where FIG. 5A is a sectional view showing the generation of the processing-liquid flow, FIG. 5B is a sectional view showing a state in which the wafers are immersed in the processing liquid, FIG. 5C is a sectional view showing a state in which the particles are discharged through the discharge hole, and FIG. 5D is a sectional view showing a state in which the wafers are pulled out from the processing vessel.

FIGS. 6A to 6D are diagrams for explaining a conventional wet processing apparatus and a conventional wet processing method, where FIG. 6A is a sectional view showing the generation of the liquid flow, FIG. 6B is a sectional view showing a state in which the wafers are immersed in the processing liquid. FIG. 6C is a sectional view showing a state in which the particles stay at the air-liquid boundary, and FIG. 6D is a sectional view showing a state in which the wafers are pulled out from the processing vessel.

FIGS. 7A to 7C are diagrams showing improved examples with respect to the conventional wet processing apparatus and method, where FIG. 7A is a perspective view of an apparatus having a processing vessel in which notches are provided at the opening thereof, FIG. 7B is a sectional view showing an apparatus having a processing vessel m which the wafers are swayed, and FIG. 7C is a sectional view showing an apparatus having a processing vessel in which outlets are provided at the side and bottom faces thereof.

### DETAILED DESCRIPTION OF THE INVENTION

Hereinafter, embodiments of the present invention will be described with reference to the appended figures.

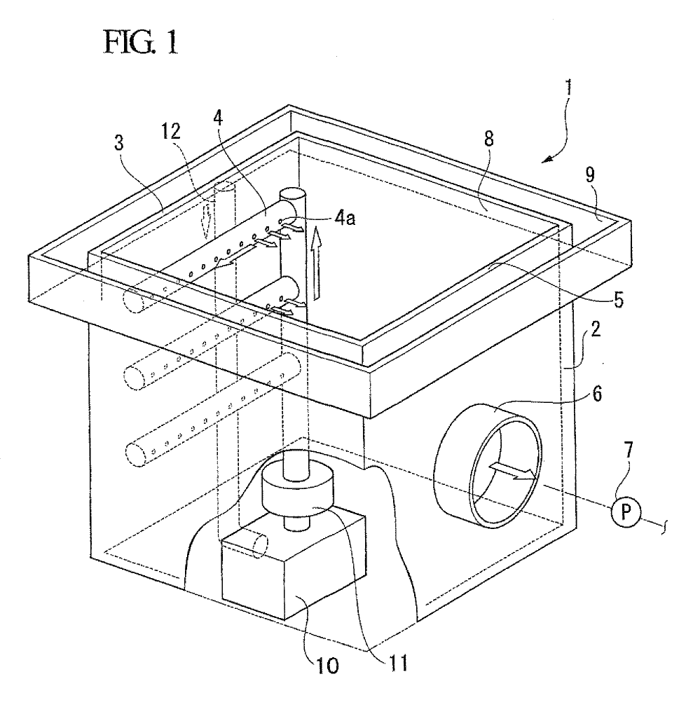

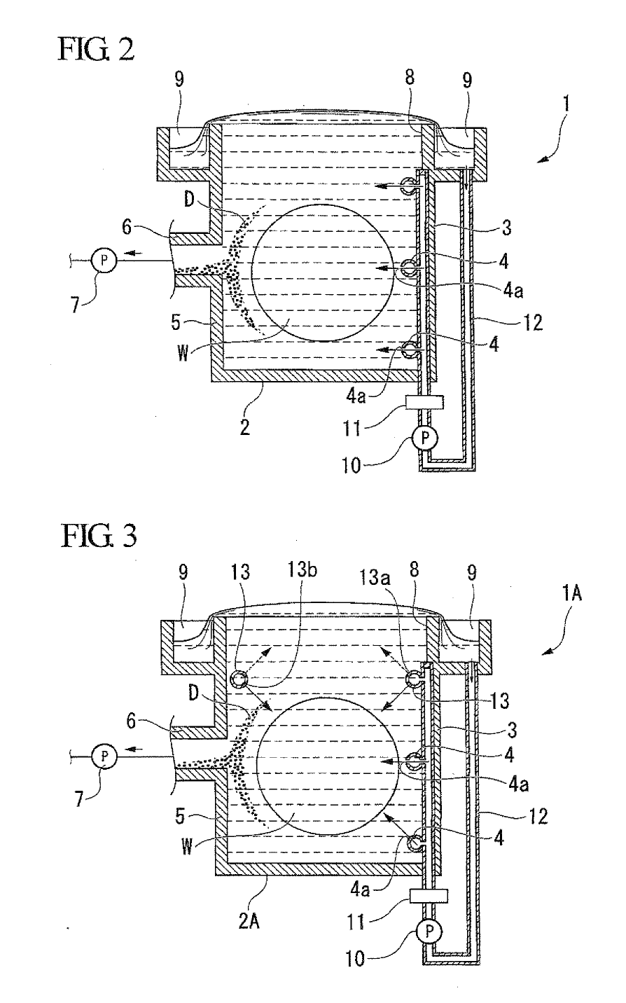

FIG. 1 is a perspective view showing a wet processing apparatus as a first embodiment of the present invention, and FIG. 2 is a sectional view thereof.

As shown in FIGS. 1 and 2, the wet processing apparatus 1 has a processing vessel 2 for containing a processing liquid, wherein wafers can be held in parallel in the cross direction in a manner such that faces of any adjacent wafers W face each other while the wafers W are immersed in the processing liquid. At a first side wall 3, which is perpendicular to the faces of the wafers W, a plurality of processing-liquid supply mechanisms 4 are arranged in parallel in the vertical direction, each having a cylinder-pipe form. Each processing-liquid supply mechanism 4 has a plurality of outlets 4a, so that the processing liquid flows horizontally and in parallel to the faces of each wafer W. At the center of a second side wall 5, which faces the first side wall 3, a discharge hole 6 is provided.

Preferably, each processing-liquid supply mechanism 4 has a form by which installation of the mechanism is easy, and the volume thereof can be minimized. Such a form may be a complete-cylinder pipe form, but is not specifically limited.

The processing-liquid supply mechanisms 4 need to be arranged so as to produce a uniform flow of the supplied processing liquid, and thus may be arranged in parallel in the cross direction. In addition, they may be embedded in the first side wall 3. The pipe system 12 has a part for coupling the processing-liquid supply mechanisms 4, and this part may be arranged on the outside of the processing vessel 2 (i.e., the inside vessel). Therefore, there is no specific structural limitation for the processing-liquid supply mechanisms 4.

The shape and arrangement of the outlets 4a are also not specifically limited. However, it is preferable to arrange the plurality of outlets 4a at regular intervals, so as to produce a uniform flow of the jetted processing liquid. For example, when processing 50 wafers W, 51 outlets 4a may be provided in a manner such that a hole (of the outlet) is present between every adjacent wafer W, and two holes are also provided on both sides of the 50 wafers W.

The discharge hole 6 must be arranged in the second side wall 5 in a manner such that it faces the outlets 4a.

An outside vessel 9 is provided so that it surrounds the peripheral edge of the opening 8 of the processing vessel 2. The pipe system 12, at which a circulation pump 10 and a filter 11 are provided, couples the bottom of the outside vessel 9 with the outlets 4a, so that the processing liquid, which overflows from the opening 8 of the processing vessel 2, is once stored in the outside vessel 9, and then circulated through the pipe system 12. The circulated processing liquid is jetted from the outlets 4a again.

The processing liquid may be a chemical liquid or water in accordance with the target wet processing. When using water, the overflowing liquid may be directly discharged from the opening 8. However, when using a chemical liquid, it is preferable to collect the liquid by means of the outside vessel 9 and make it flow through the pipe system 12, so that the liquid is circulated by means of the circulation pump 10 while removing particles D through the filter 11. Such reuse of the liquid is economical and preferable.

In addition, a discharge pump 7, provided on the outside of the processing vessel 2, is coupled to the discharge hole 9, so that the processing liquid jetted from the outlets 4a is forcibly discharged via the discharge hole 6 while suctioning the liquid by means of the discharge pump 7. Accordingly, the processing liquid can flow horizontally inside the processing vessel 2. Additionally, as the liquid flow is forcibly controlled, it is possible to reduce a turbulent flow, thereby improving uniformity along the faces of wafers with respect to the effects of wet etching or rinsing.

FIG. 3 shows a wet processing apparatus 1A as a second embodiment of the present invention. In the wet processing apparatus 1A, second processing-liquid supply mechanisms 13 are provided at the first side wall 3 and the second side wall 5 of a processing vessel 2A, where they are provided at the same height above the processing-liquid supply mechanisms 4. The second processing-liquid supply mechanisms 13 each have assistant outlets 13a which are directed upward so as to jet the processing liquid toward the air-liquid boundary, so that a slight amount of particles D which stay around the air-liquid boundary can be forcibly made to overflow. Therefore, it is possible to more effectively prevent re-adhesion of the particles D. It is considerably effective if the above-described jetting of the processing liquid toward the air-liquid boundary is performed immediately before removing the wafers W from the processing vessel 2A when the wet processing is completed.

In addition, each second processing-liquid supply mechanism 13 also has downward outlets 13b, and the outlets 4a of the processing-liquid supply mechanism 4 which is provided on the lower side of the vessel 2A are arranged upward, so that the processing liquid is jetted through each outlet towards the wafers W. Accordingly, it is possible to improve the wet processing performance. The other structure of the second embodiment is identical to the first embodiment.

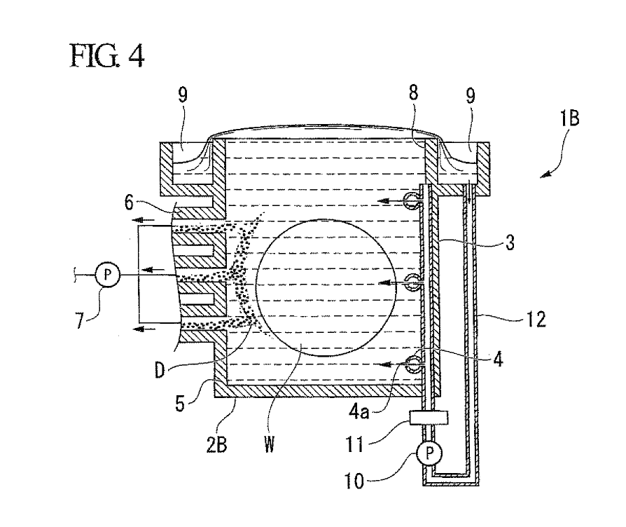

FIG. 4 shows a wet processing apparatus 1B as a third embodiment of the present invention In the wet processing apparatus 1B, a plurality of discharge holes 6 are provided at the second side wall 5 of a processing vessel 2B, so as to improve the discharge performance. The other structure of the third embodiment is identical to the first embodiment.

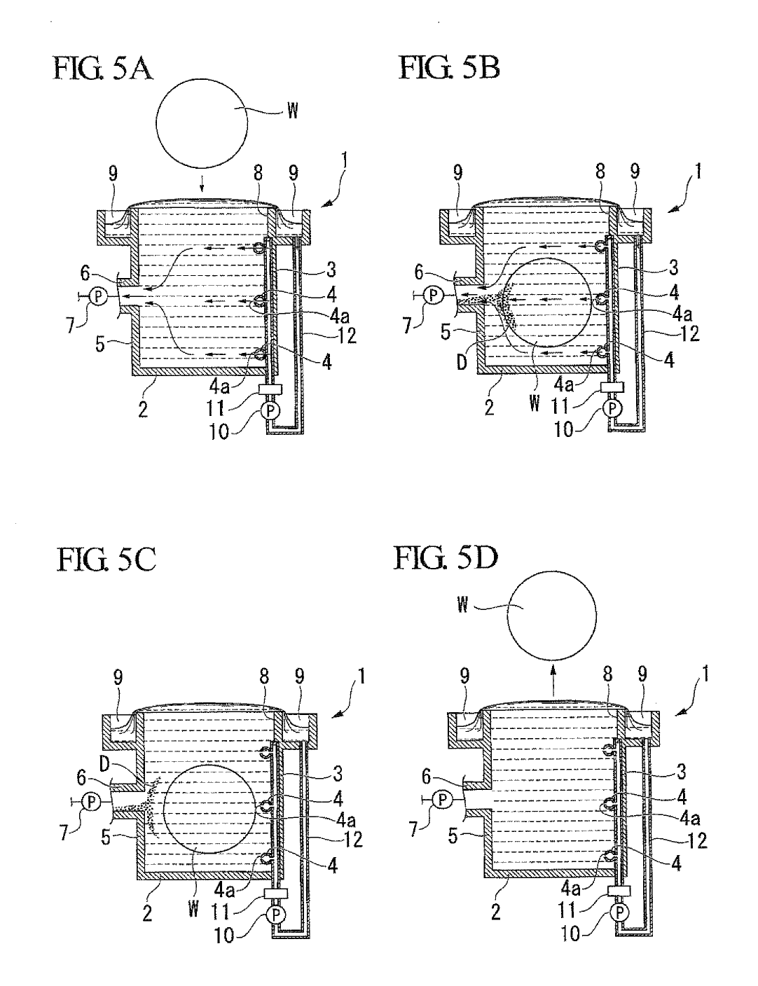

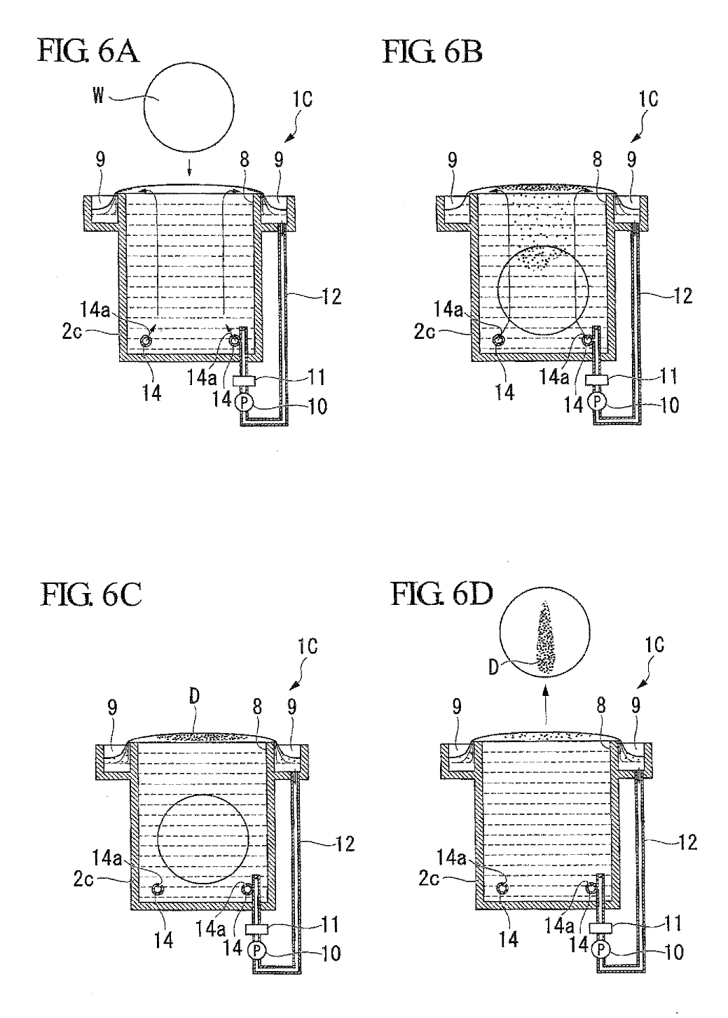

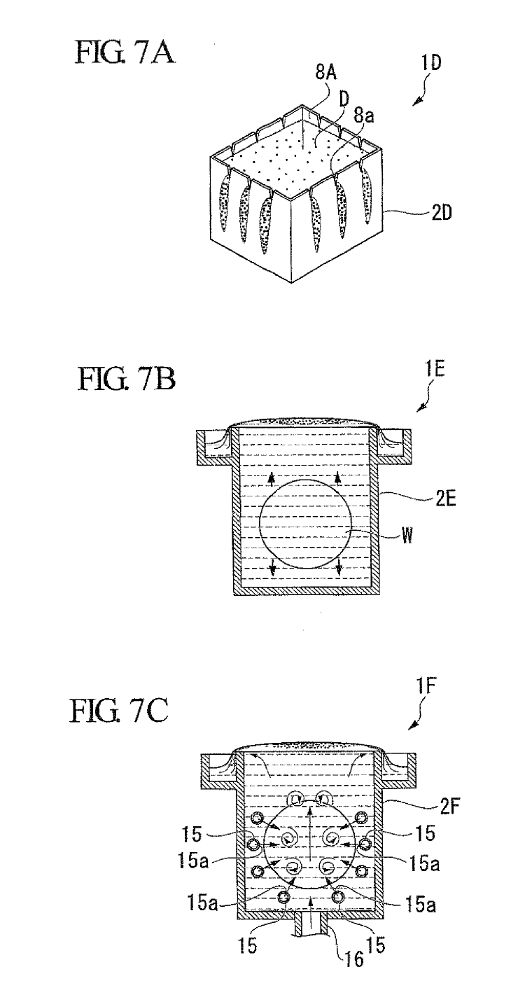

Next, a wet processing method using a wet processing apparatus in accordance with the present invention will be explained with reference to FIGS. 5A to 5D. Even though FIGS. 5A to 5D show the wet processing apparatus 1, the method may be similarly applied to the wet processing apparatus 1A or 1B. The wet processing may be performed for cleaning or wet-etching a semiconductor wafer.

First, as shown in FIG. 5A, before starting the immersion of wafers W, the processing liquid is jetted from the outlets 4a so that it flows horizontally, and then forcibly discharged through the discharge hole 6, thereby generating a liquid flow inside the vessel 2. In this process, (i) jetting and suctioning (using the pump 7) may be performed simultaneously, or (ii) suctioning may start first, and jetting may start later. When starting the suction early, it is possible to prevent the particles D from moving toward the air-liquid boundary at the opening 8.

Next, as shown in FIG. 5B, the wafers W are immersed in the processing liquid, so as to perform the wet processing. During the wet processing, the horizontal liquid flow is maintained, and the particles D generated from the wafers W are forwarded along the liquid flow. Therefore, as shown in FIG. 5C, the particles D are discharged from the discharge hole 6 without floating at the air-liquid boundary above the wafers W.

Lastly, as shown in FIG. 5D, when the wet processing of the wafers W is completed, they are removed from the processing liquid. In this process, as the particles D do not stay at the air-liquid boundary, it is possible to prevent re-adhesion of the particles D to the wafers W when they are pulled out.

As described above, when using the wet processing apparatus 1, 1A, or 1B in accordance with the present invention, the hydraulic pressure of the horizontal flow from the outlets to the discharge hole is higher than the buoyancy of the particles D generated from the wafers. Therefore, the particles D do not appear at the air-liquid boundary, and thus do not stay at the boundary. Therefore, when pulling out the wafers W, they can be removed from the processing liquid without bringing the particles D.

In addition, after the processing liquid, which overflows from the opening 8, is first stored in the outside vessel 9, and then circulated through the pipe system 12, so that it is jetted from the outlets 4a again. Therefore, even the processing liquid, which has been used for the wet processing, can be reused by circulating it using the circulation pump 10 while removing the particles D by means of the filter 11.

### CONCRETE EXAMPLE

A concrete example which was actually performed will be explained in detail. However, the present invention is not limited to the example.

By using the wet processing apparatus 1 as shown in FIGS. 1 and 2, 50 wafers W were cleaned under the following conditions. That is, the number of the processing-liquid supply mechanisms 4 (pipes) is three, each having a complete-cylinder pipe form. In each mechanism 4, 51 outlets 4a are provided at regular intervals.

As shown in FIG. 5A, before the immersion of the wafers W, a cleaning liquid was jetted to flow horizontally, and it was forcibly discharged from the discharge hole 6, thereby producing a liquid flow inside the processing vessel 2. In this process, the suctioning operation was started, and the discharge operation was started later.

Next, as shown in FIG. 5B, the wafers W were immersed in the processing liquid, so as to clean them. During the cleaning, the liquid flow was maintained horizontally, while the particles D generated from the wafers W were forwarded along the liquid flow. Therefore, as shown in FIG. 5C, the particles D did not stay at the air-liquid boundary above the wafers W, and were discharged from the discharge hole 6.

Lastly, as shown in FIG. 5D, when the cleaning of the wafers W was completed, they were pulled out and removed from the cleaning liquid. Even when the series of the above-described processes, applied to “50 wafers W”, was repeatedly performed, no adhesion of the particles D to the wafers was founded. In addition, as the particles D did not stay at the air-liquid boundary, re-adhesion of the particles D to the wafers W could be prevented when they were pulled out.

While preferred embodiments of the present invention have been described and illustrated above, it should be understood that these are exemplary embodiments of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

The present invention is also applicable to processing of a semiconductor substrate, a print circuit board, electronic parts, and an optical disc such as CD, CDR, or DVD, instead of a semiconductor wafer as described in the above embodiments.

### INDUSTRIAL APPLICABILITY

The present invention can be effectively applied to cleaning or etching of a semiconductor device such as a DRAM (dynamic random access memory) or the like.

What is claimed is:

1. A wet processing apparatus comprising:
a processing vessel for containing a processing liquid and holding at least one wafer which is immersed in the processing liquid, wherein the processing vessel has an opening, provided on an upper side of the processing vessel, for loading and removing each wafer; and
a processing-liquid supply mechanism which has outlets at a first side wall of the processing vessel, wherein:
a discharge hole for discharging the processing liquid jetted from the outlets is provided at a second side wall of the processing vessel, where the second side wall faces the first side wall, and the outlets face the discharge hole.

2. The wet processing apparatus in accordance with claim 1, wherein:
an outside vessel for containing the processing liquid, which overflows from the opening of the processing vessel, is provided so as to surround the peripheral edge of the opening; and
a pump for circulating the contained processing liquid and a filter for filtering the processing liquid are provided at piping which is coupled to the bottom of the outside vessel and the processing-liquid supply mechanism.

3. The wet processing apparatus in accordance with claim 1, wherein:
a discharge pump for forcibly discharging the processing liquid is coupled to the discharge hole.

4. The wet processing apparatus in accordance with claim 1, wherein:
the first and second side walls have assistant outlets which are provided above the outlets of the processing-liquid supply mechanism and have substantially the same height; and
the processing liquid is jetted from the assistant outlets toward the boundary between the processing liquid and air at the opening of the processing vessel.

5. The wet processing apparatus in accordance with claim 1, wherein:
the opening is provided so as to load and remove each wafer in a direction substantially perpendicular to a substantially horizontal flow of the processing liquid.

6. The wet processing apparatus in accordance with claim 1, wherein:
the hydraulic pressure of a substantially horizontal flow from the outlets to the discharge hole is higher than the buoyancy of particles generated from each wafer.

7. A wet processing method comprising the steps of:
storing a processing liquid in a processing vessel;
loading at least one wafer from an opening, provided on an upper side of the processing vessel, and holding each wafer, which is immersed in the processing liquid, in the processing vessel;
jetting the processing liquid from outlets of a processing-liquid supply mechanism provided at a first side wall of the processing vessel;
discharging the processing liquid from a discharge hole provided at a second side wall of the processing vessel, where the second side wall faces the first side wall, so as to produce a substantially horizontal flow of the processing liquid; and
removing particles, which are generated from each wafer, along the horizontal flow of the processing liquid, so as to perform a wet processing without making the particles stay at the boundary between the processing liquid and air at the opening of the processing vessel.

8. The wet processing method in accordance with claim 7, wherein:
the processing liquid, which overflows from the opening of the processing vessel, is contained in an outside vessel provided so as to surround the peripheral edge of the opening, and then circulated through piping at which a filter and a pump are provided, so that the processing liquid is jetted from the outlets, which are coupled with the bottom of the outside vessel, after removing the particles, which are included in the processing liquid, through the filter.

9. The wet processing method in accordance with claim 7, wherein:
the wet processing is performed while forcibly discharging the processing liquid by using a discharge pump coupled to the discharge hole.

10. The wet processing method in accordance with claim 7, wherein:
immediately before removing each wafer from the processing vessel when the wet processing is completed, the processing liquid is jetted toward the boundary between the processing liquid and air, from assistant outlets which are provided at the first and second side walls and above the outlets of the processing-liquid supply mechanism, and have substantially the same height.

11. A processing apparatus comprising:
a processing vessel for containing a processing liquid and holing at least one object which is immersed in the processing liquid, wherein:
an outlet which supplies the processing vessel with the processing liquid is provided; and
a discharge hole is provided at an inner side wall of the processing vessel, so as to discharge the processing liquid.

12. The processing apparatus in accordance with claim 11, wherein:
the processing vessel has another discharge hole so as to discharge the processing liquid which overflows.
